(19) United States
(12) Patent Application Publication
(10) Pub. No.: US 2002/0171237 A1
(43) Pub. Date: Nov. 21, 2002

(54) Smart bag for holding booklets, manuals, catalogues, manuals with compact discs, and the like

(76) Inventor: Min Han Wu, Taipei (TW)

Correspondence Address: WU Min Han, P.O. Box 82-144, Taipei, TW

(21) Appl. No.: 09/860,544

(22) Filed: May 21, 2001

(51) Int. Cl. B42D 3/00; B42F 13/00

(52) U.S. Cl. 281/29

(57) ABSTRACT

A smart bag includes two pocket portions and a perforated portion between the two pocket portions, the perforated portion including a single-layered sheet formed with two rows of holes, the pocket portion having two single-layered sheets, the perforated portion having a folding line at a central portion thereof so that the smart bag can be folded into two leaves each having a pocket which is open at the inner side but closed at the outer side.

### BACKGROUND OF THE INVENTION

(a) Technical Field of the Invention

This invention is related to a smart bag and in particular to one for holding booklets, manuals, catalogues, manuals and in particular to specifications or manuals with an accompanying compact disc, a floppy disc, a warranty card and the like.

(b) Description of the Prior Art

In our daily life, we have to keep a lot of booklets, manuals, catalogues, CDs and the like for future reference. However, there are a number of problems in keeping them:

A. In order to keep the booklets, manuals, catalogues, CDs and the like, there will arise the following problems:

1. They cannot stand upright by themselves on the bookshelf, tend to bend and are different in height thereby making them untidy and disorderly in appearance.

2. As they are easily hidden in other books, it will be often difficult to locate them.

3. Today in the information era compact discs, floppy discs and warranty cards are found everywhere, so it is very difficult for the user to keep these, thereby causing the user much inconvenience in use. Further, finding a suitable storage device which enables the user to quickly distinguish and locate the appropriate disc or card for use is very difficult.

4. Because they are of different sizes, it will be difficult to place them in a drawer in order thus making it difficult to find them

5. As manuals and catalogues are used very often, the covers are easily damaged or even broken.

B. If the documents are kept in bags, it will be easy to keep single-sheet documents, but it will have the following problems when required to keep booklets and catalogues:

1. The booklets and catalogues cannot be kept in place within a bag, so that they will slide within the bag thus often causing damage to the bag.

2. If the booklets are much smaller than the bag, they will be squeezed in the innermost portion of the bag.

3. As the booklets are placed in the innermost portion of the bag, it will be very inconvenient to take them out of the bag and they will easily be lost if the user forgets to put them back.

C. If ring clips, which are the most commonly used way to keep information, are used to keep booklets (the commonly used way to keep information), the following problems will occur:

1. It is necessary to punch holes in the booklet in order to mount a ring clip thus causing damage to the booklet.

2. It is necessary to buy one or more punching machines in order to make holes of different sizes on various booklets thereby wasting money.

Therefore, it is an object of the present invention to provide an improved binder for booklets, manuals, catalogues . . . etc. and in particular to specifications or manuals with an accompanying compact disc, a floppy disc, a warranty card and the like which is adjustable to suit different storage space by a sliding process, and can obviate and mitigate the above-mentioned drawbacks.

### SUMMARY OF THE INVENTION

This invention is related to a smart bag and in particular to one for holding booklets, manuals, catalogues, manuals with an accompanying compact disc, and the like.

It is the primary object of the present invention to provide a smart bag which includes two pocket portions and a perforated portion between the two pocket portions, the perforated portion including a single-layered sheet formed with two rows of holes, the pocket portion having two single-layered sheets, the perforated portion having a folding line at a central portion thereof so that the smart bag can be folded into two leaves each having a pocket which is open at the inner side but closed at the outer side.

It is another object of the present invention to provide a smart bag which comprises a single leaf with a pocket portion and a perforated portion, wherein said pocket portion has a pocket which is open at two opposite sides thereof and said perforated portion has a row of holes.

The foregoing objects and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts. Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a development view of the present invention;

FIG. 2 is a perspective view of the present invention;

FIG. 3 is a sectional view taken along line 3-3 of FIG. 1;

FIG. 4 is a sectional view taken along line 4-4 of FIG. 1;

FIG. 5 illustrates how to fold the present invention;

FIG. 6 illustrates how to put a booklet inside the present invention;

FIG. 7 illustrates the folding condition of the present invention;

FIG. 8 illustrates how to move the present invention backward with respect to the booklet;

FIG. 9 illustrates how to put the present invention inside a ring binder;

FIG. 10 is perspective view of a second preferred embodiment of the present invention;

FIG. 11 illustrates how to put a booklet in the second preferred embodiment of the present invention;

FIG. 12 illustrates how to move the second preferred embodiment of the present invention backward with respect to the booklet;

FIG. 13 illustrates the engagement between the booklet and the second preferred embodiment of the present invention;

FIG. 13a is enlarged view of a portion of FIG. 13;

FIG. 14 illustrates how to put the second preferred embodiment in a ring binder;

FIG. 15 illustrates how to put two smart bags according to the second preferred embodiment according to the present invention in a ring binder;

FIG. 16 is a perspective view of a third preferred embodiment of the present invention;

FIG. 17 is a development view of the third preferred embodiment of the present invention;

FIG. 18 is a sectional view taken along line 18-18 of FIG. 17;

FIG. 19 illustrates how to fold the flap of the third preferred embodiment of the present invention outwardly;

FIG. 20 illustrates how to engage a booklet with the third preferred embodiment of the present invention;

FIG. 21 is a sectional view of FIG. 20;

FIG. 22 illustrates how to put the third preferred embodiment of the present invention inside a ring binder; and

FIG. 23 illustrates how to put two smart bags according to the third preferred embodiment of the present invention inside a ring binder.

FIG. 24 illustrates that the surface of the pocket portion of the smart bag is formed with one or more cuts for mounting pockets.

FIG. 25 illustrates the application of the embodiment shown in FIG. 24.

FIG. 26 illustrates how the present invention is used for holding newspaper type publication.

FIG. 27 is a working view of the embodiment shown in FIG. 26.

### DETAILED DESCRIPTION OF THE PREFERRED EMBODIMENT

For the purpose of promoting an understanding of the principles of the invention, reference will now be made to the embodiment illustrated in the drawings. Specific language will be used to describe same. It will, nevertheless, be understood that no limitation of the scope of the invention is thereby intended, such alterations and further modifications in the illustrated device, and such further applications of the principles of the invention as illustrated herein being contemplated as would normally occur to one skilled in the art to which the invention relates.

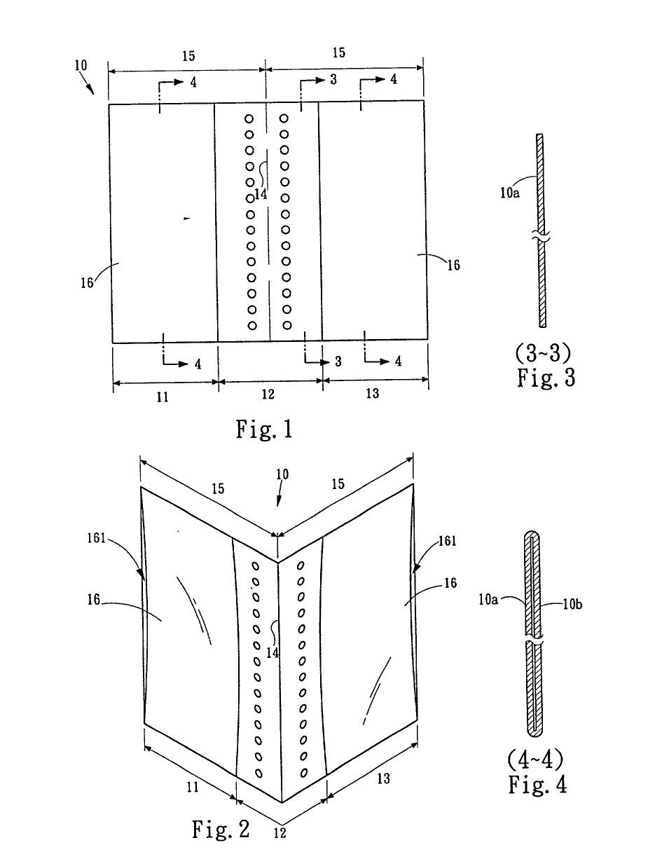

FIG. 1 is a development view of the present invention and FIG. 2 is a perspective view of the present invention. As shown, the smart bag 10 according to the present invention is made of plastic and comprises two pocket portions 16 and a perforated portion 14 between the two pocket portions 16. The perforated portion 14 includes a single-layered sheet 10a (see FIG. 3) formed with two rows of holes (see FIG. 1), while the pocket portion 16 has two single-layered sheets 10a and 10b (see FIG. 4). The perforated portion 12 has a folding line 14 at the central portion so that the smart bag 10 can be folded into two leaves 15 each having a pocket 16 which is open at the inner side but closed at the outer side.

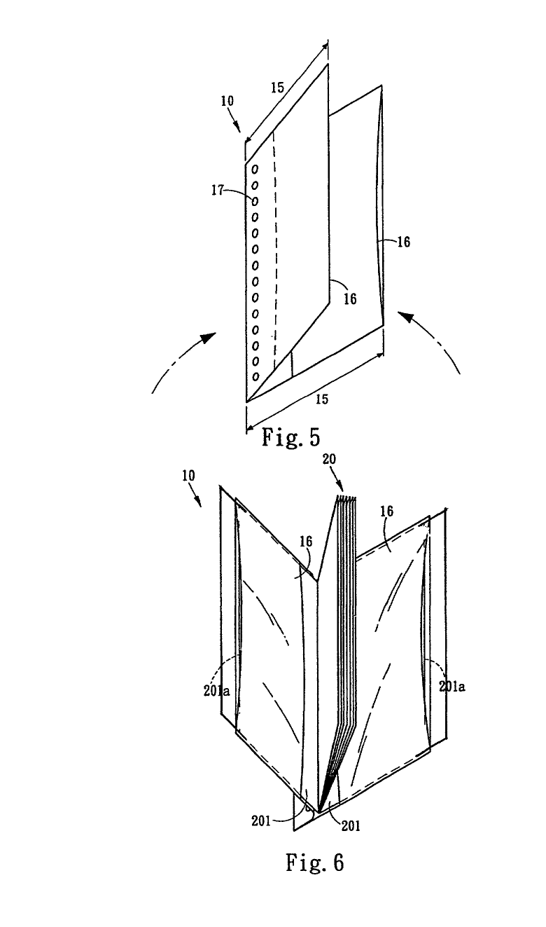

Referring to FIG. 5, when the perforated portion 12 is folded along the folding line 14, the two rows of holes 17 at the perforated portion 12 will be aligned into one row of holes 17 thereby enabling the smart bag 10 to be engaged with a ring binder.

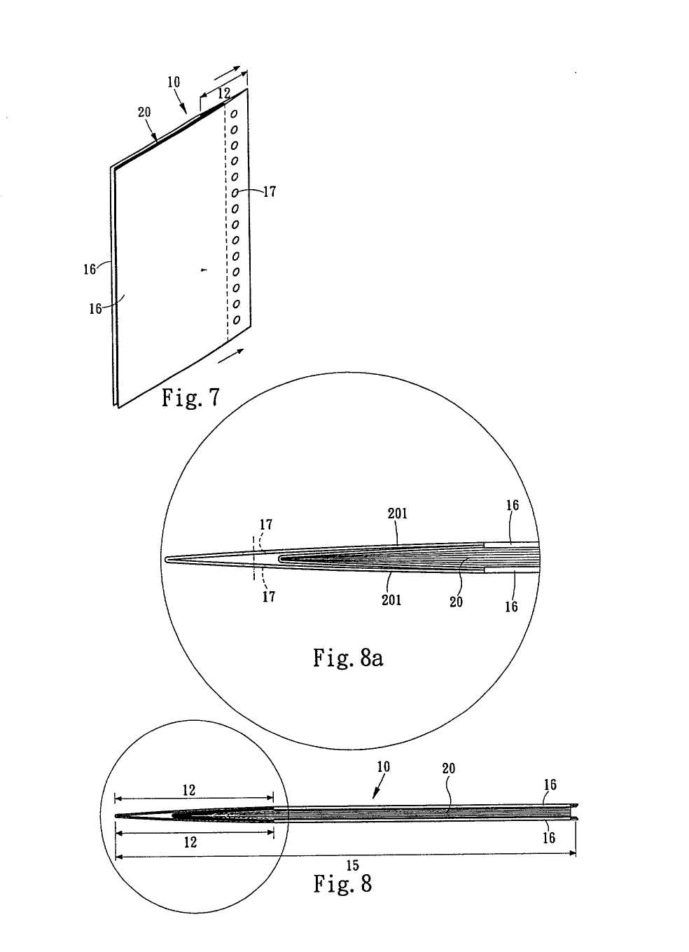

Referring to FIG. 6, the front and back covers 201 and of a booklet 20 are each inserted into a respective one of the pocket portions 16 of the smart bag 10 until the outer edges 201a of the covers 201 are in contact with the innermost portion of the pocket portions 16. Thereafter, the smart bag 10 is closed to make the perforated portion 14 close at a distance beyond the spine of the booklet 20 (see FIGS. 7 and 8).

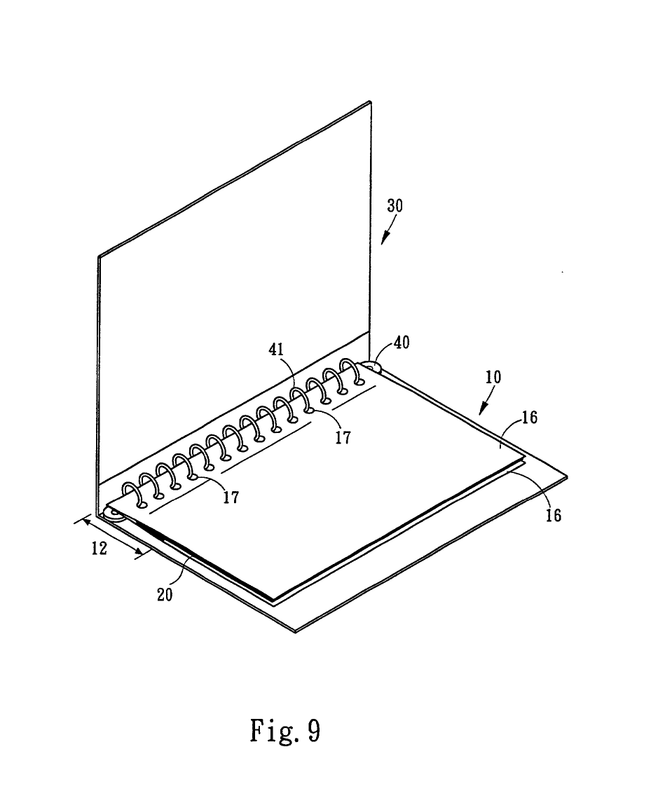

Referring to FIG. 9, the perforated portion 14 of the smart bag 10 is engaged with rings 41 of a ring clip 40 of a ring binder 30 thereby forming a loose-leaf folder and therefore making it easy to turn over the pages of the booklet 20. In addition, the front and back covers of the booklet 20 are protected by the pocket portions 16 of the smart bag 10.

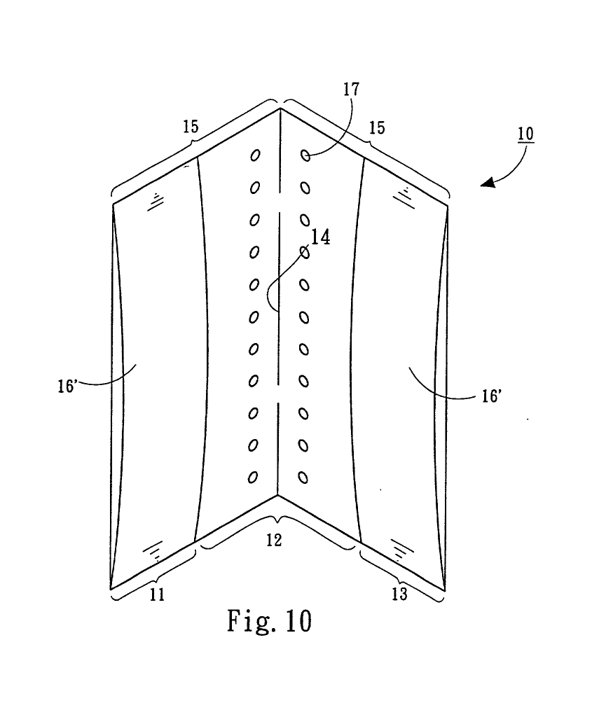

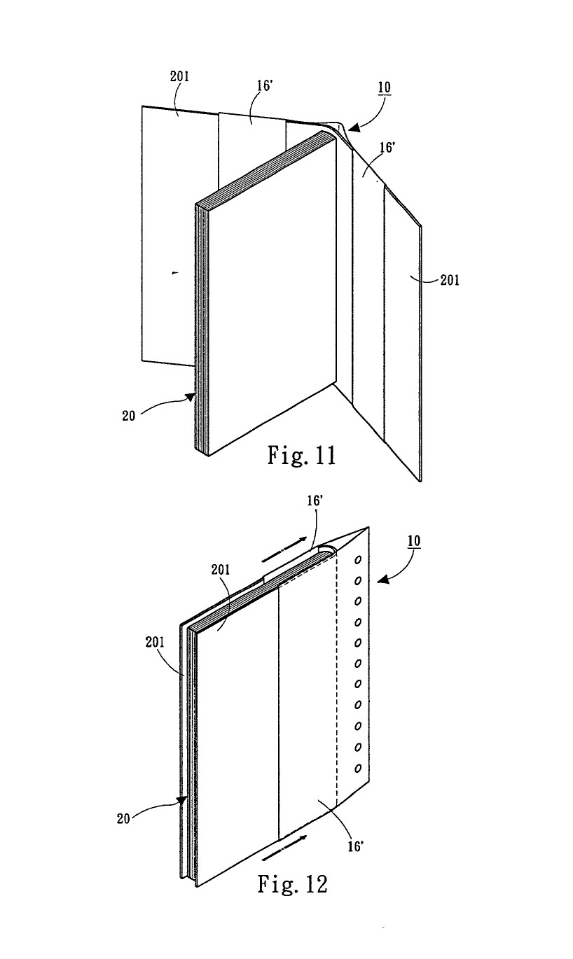

FIG. 10 is perspective view of a second preferred embodiment of the present invention. As shown, the pockets 16 and 16′ of the pocket portions 11 and 13 of smart bag 10 are open at two opposite sides.

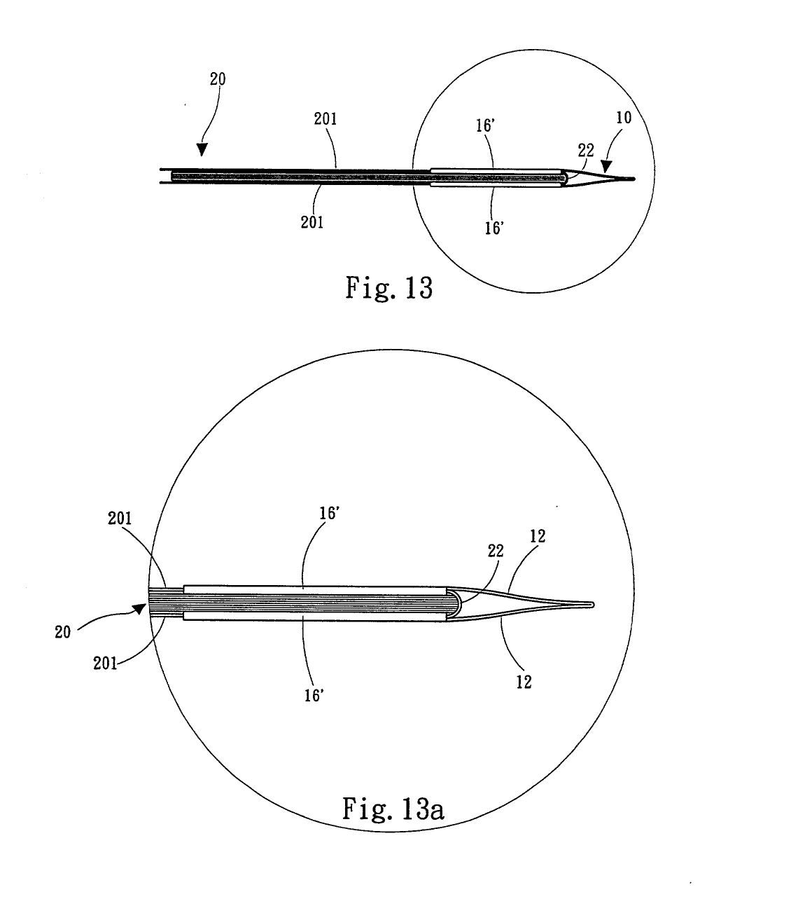

Referring to FIG. 1, a booklet 20 is engaged with the smart bag 10 with the front and back covers 201 of the former going through the pockets 16 and 16′ of the latter. Then, the smart bag 10 is closed and pulled backward as shown in FIG. 12 until the inner edges of the pockets 16 and 16′ are in contact with the folding lines of the front and back covers 201 (see FIGS. 13 and 13a).

Referring to FIG. 14, as the perforated portion of the smart bag 10 is pulled out of the booklet 20, the smart bag can be mounted in the rings 40 of a ring folder 30 so that the booklet 20 can be read conveniently.

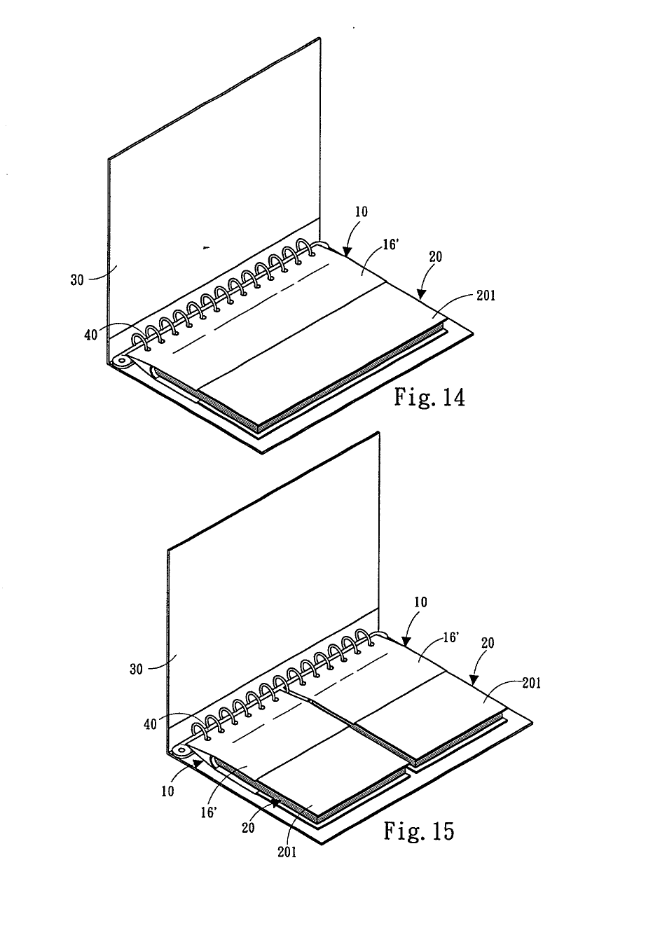

Referring to FIG. 15, if the booklet 20 is small in size, two or more booklets 20 can be conveniently mounted in the rings 40 of a ring folder 30 thus facilitating the storage of the booklets.

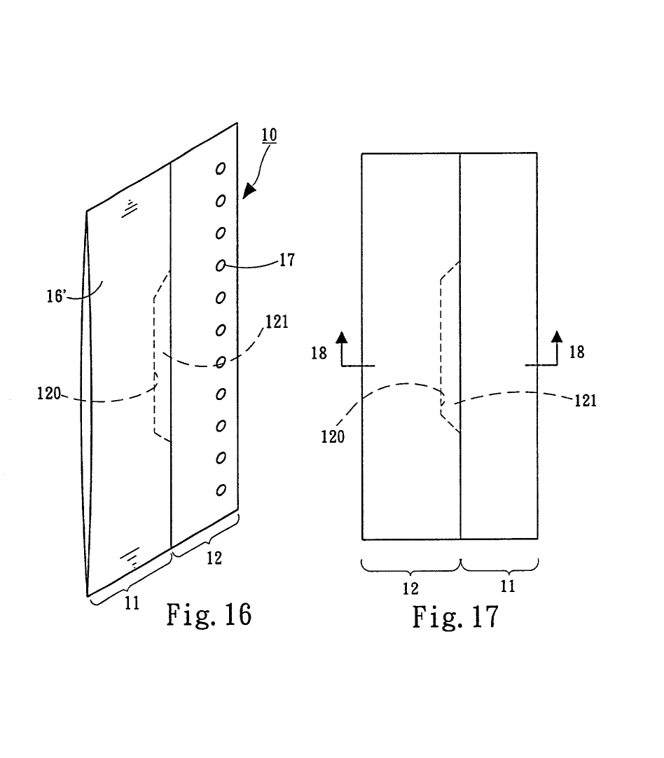

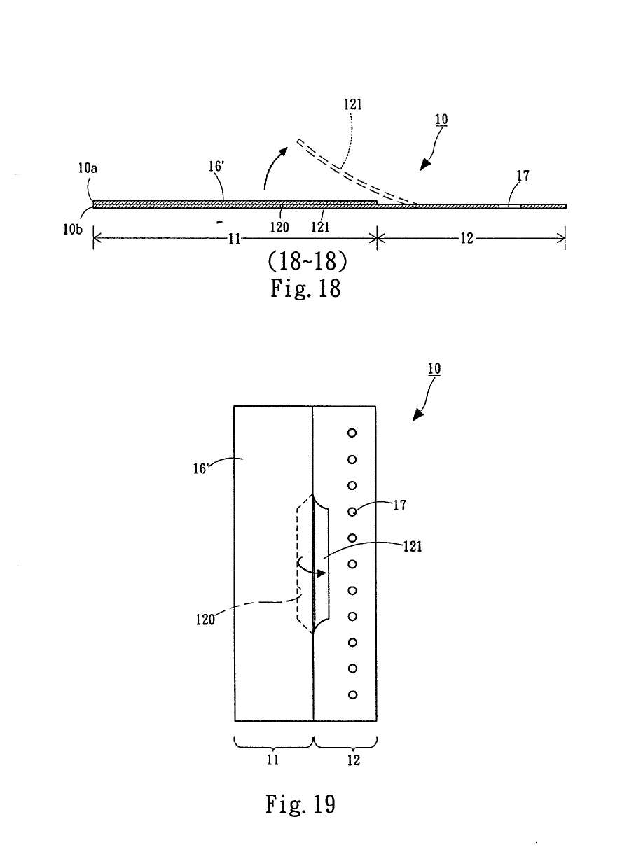

FIG. 16 illustrate a third preferred embodiment of the present invention. As shown, the smart bag 10 includes a single leaf having a pocket portion 11 and a perforated portion 12, wherein the pocket portion 11 has a pocket 16′ which is open at two opposite sides and the perforated portion 12 has a row of holes 17. A line 120 is made on the inner edge of the pocket 16′ thereby forming a flap 121 which can be moved as shown in FIGS. 18 and 19.

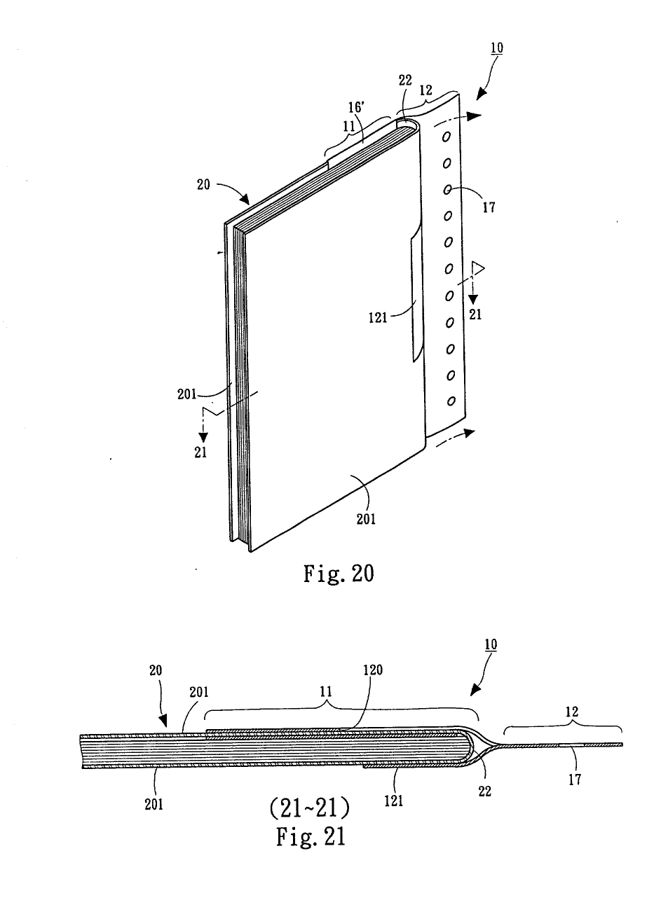

Referring to FIGS. 20 and 21, the smart bag according to the third preferred embodiment of the present invention can be engaged with a booklet 20 with the pocket 16′ receiving a cover 201 of the booklet 20. Then, the smart bag 10 is pulled backward, so that the perforated portion 12 is positioned out of the booklet 20, the inner edge of the pocket 16′ bears against the folding line of a cover of the booklet, and the flap 121 abuts the other cover of the booklet.

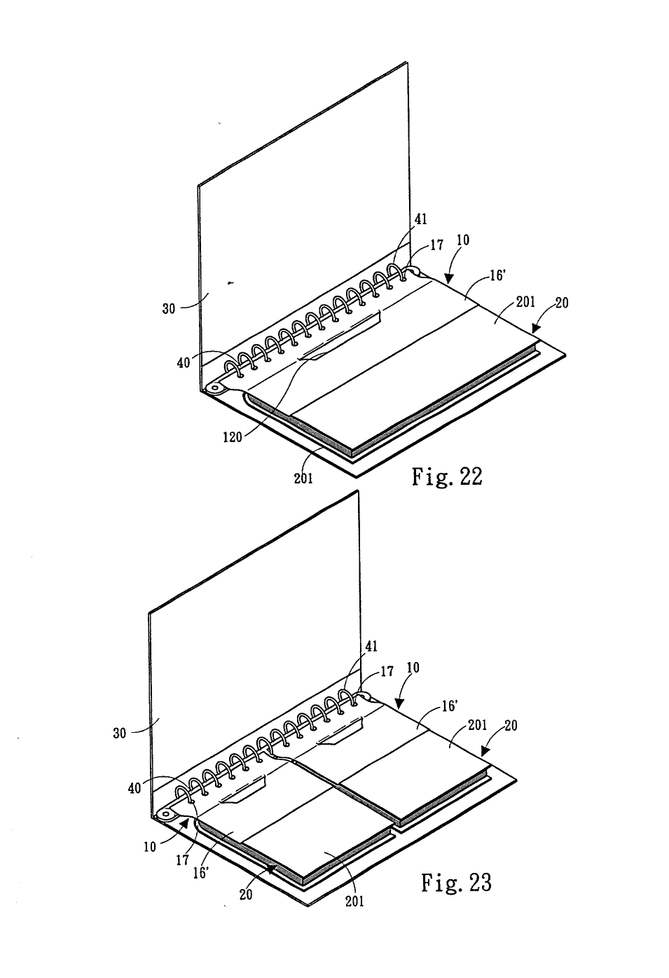

Referring to FIG. 22, as the perforated portion of the smart bag 10 is pulled out of the booklet 20, the smart bag can be mounted in the rings 40 of a ring folder 30 so that the booklet 20 can be read conveniently.

Referring to FIG. 23, if the booklet 20 is small in size, two or more booklets 20 can be conveniently mounted in the rings 40 of a ring folder 30 thus facilitating the storage of the booklets.

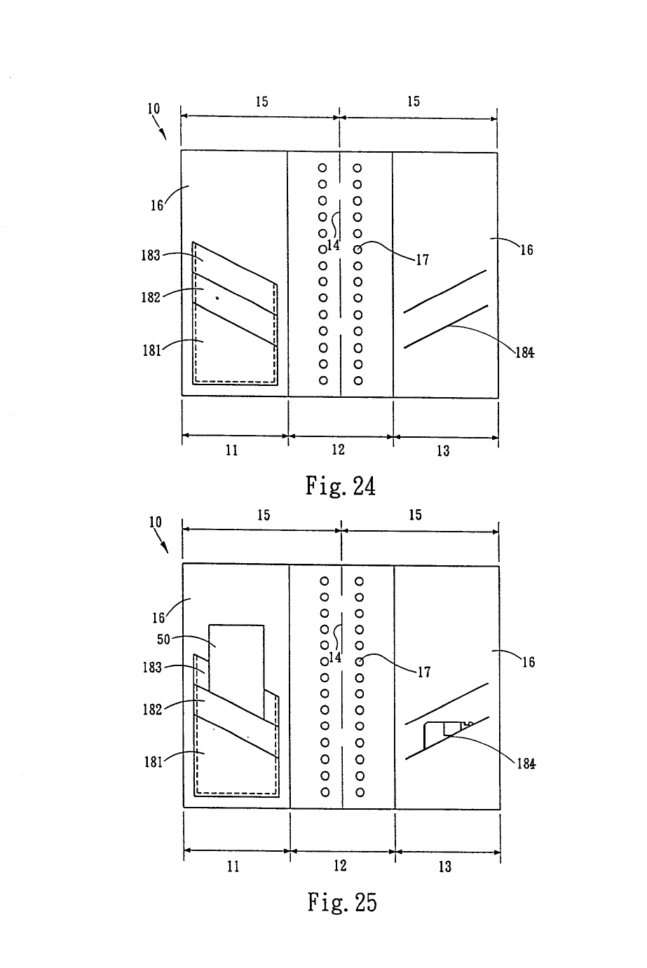

Referring to FIG. 24, the surface of the pocket portion 16 of the smart bag 10 is formed with one or more cuts 184 for mounting pockets 181, 182 and 183 by high frequency heating technology.

FIG. 25 illustrates the application of the embodiment shown in FIG. 24. As shown, business cards, warranty cards, compact discs, floppy discs, magnetic cards and the like can be inserted into the pockets.

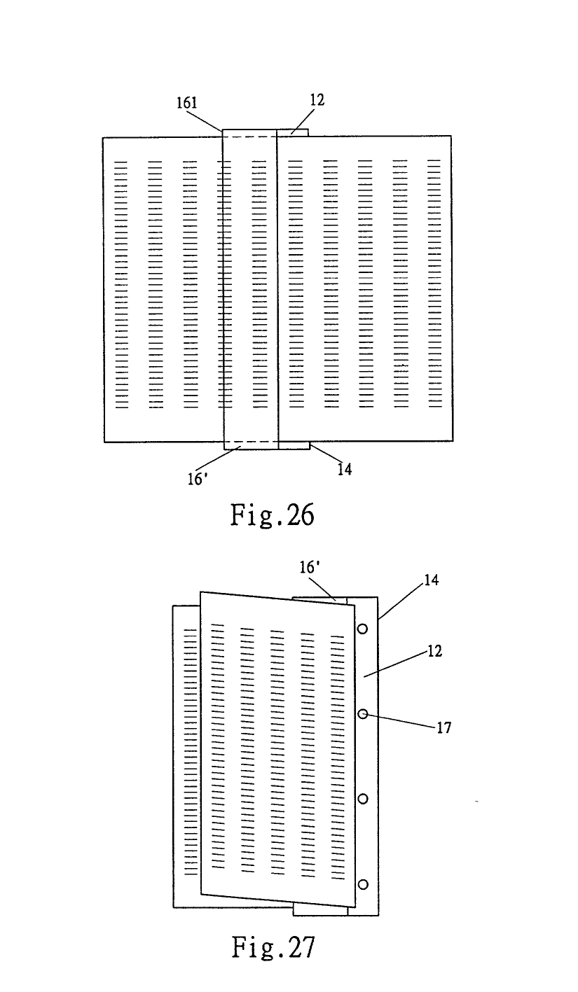

FIG. 26 illustrates how the present invention is used for holding newspaper type publication.

FIG. 27 is a working view of the embodiment shown in FIG. 26.

In conclusion, the present invention has the following advantages:

1. The smart bag can be used for holding booklets, catalogues and the like so that the booklets, catalogues and the like can be easily turned over for reading.

2. The booklets, catalogues and the like can be kept inside the smart bag without bending thereby making it easy to arrange them in order.

3. It is unnecessary to punch holes in the booklets, catalogues and the like.

4. The booklets, catalogues and the like can be easily searched when put inside the smart bag.

5. The smart bag can receive one or more smaller booklets and the like thereby reducing the space required for storing them.

6. The booklets, catalogues and the like can be well protected by the smart bag.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A smart bag comprising two pocket portions and a perforated portion between said two pocket portions, said perforated portion including a single-layered sheet formed with two rows of holes, said pocket portion having two single-layered sheets, said perforated portion having a folding line at a central portion thereof so that said smart bag can be folded into two leaves each having a pocket which is open at the inner side but closed at the outer side.

2. The smart bag as claimed in claim 1, wherein said pockets are open at two opposite sides thereof.

3. The smart bag as claimed in claim 1, wherein said holes are pre-formed on said perforated portion.

4. A smart bag comprising a single leaf having a pocket portion and a perforated portion, wherein said pocket portion has a pocket which is open at two opposite sides thereof and said perforated portion has a row of holes.

5. The smart bag as claimed in claim 4, wherein said holes are pre-formed on said perforated portion.

6. The smart bag as claimed in claim 1, wherein a line is made on an inner edge of said pocket thereby forming a flap.
